(19) United States
(12) Patent Application Publication
(10) Pub. No.: US 2023/0281588 A1
(43) Pub. Date: Sep. 7, 2023

(54) AMBIENT WALLET SELECTION FOR SENSOR-BASED CHECKOUT SYSTEMS

(71) Applicant: The Toronto-Dominion Bank, Toronto (CA)

(72) Inventors: Milos DUNJIC, Oakville (CA); David Samuel TAX, Toronto (CA); Jonathan Joseph PRENDERGAST, West Chester, PA (US); Asad JOHEB, Toronto (CA); Christopher Mark JONES, Villanova, PA (US); Thomas Osman KELLY, Wenonah, NJ (US)

(73) Assignee: The Toronto-Dominion Bank, Toronto (CA)

(21) Appl. No.: 17/684,743

(22) Filed: Mar. 2, 2022

(51) Int. Cl. G06Q 20/20; G06Q 20/36

(52) U.S. Cl. CPC G06Q 20/204; G06Q 20/363

(57) ABSTRACT

In another aspect, a computer-implemented method is described. The method includes: detecting that an electronic device that has been previously configured to communicate with the ambient commerce system is at the ambient commerce premises, the electronic device associated with an entity; receiving, from the electronic device, a wallet identifier, the wallet identifier uniquely identifying a particular wallet that is to be used to complete an ambient commerce transaction; identifying, based on the sensor, one or more items that are to be associated with the ambient commerce transaction; and processing the ambient commerce transaction for the identified one or more items using the particular wallet identified by the wallet identifier.

### TECHNICAL FIELD

The present application relates to ambient commerce systems and, more particularly, to systems and computer-implemented methods to enable ambient wallet selection for a sensor-based checkout system.

### BACKGROUND

Ambient commerce systems are sometimes deployed at an ambient commerce premises such as a store to allow customers to skip a traditional checkout process. Often, a customer will tap a credit card or app at a reader when they enter a store and the ambient commerce system monitors which items the customer leaves the store with and then automatically processes a payment for such items. Ambient commerce systems offer a cashier-less checkout experience. In this way, a customer does not have to participate in a traditional checkout process—they simply walk out of the store with any items that are to be purchased.

Ambient commerce systems offer numerous benefits including, for example, reducing the possibility of theft, increasing the speed of checkout, and reducing human resource requirements. One common drawback to ambient commerce systems is that a customer is typically required to use a digital wallet associated with a merchant operating the ambient commerce system in order to complete a sensor-based checkout process.

### BRIEF DESCRIPTION OF THE DRAWINGS

Embodiments are described in detail below, with reference to the following drawings:

FIG. 1 is a plan view of an ambient commerce system at an ambient commerce premises illustrating an operating environment of an example embodiment;

FIG. 2 is a schematic operation diagram illustrating an operating environment;

FIG. 3 is a high-level schematic diagram of an example computer device;

FIG. 4 shows a simplified organization of software components stored in a memory of the example computer device of FIG. 3;

FIG. 5 is a flowchart showing operations performed by a computer system in configuring a wallet identifier;

FIG. 6 is an example interface in accordance with example embodiments;

FIG. 7 is a flowchart showing operations performed by a computer system in processing an ambient commerce transaction in accordance with example embodiments; and

FIG. 8 is a flowchart showing operations performed by a computer system in processing an ambient commerce transaction in accordance with example embodiments.

Like reference numerals are used in the drawings to denote like elements and features.

### DETAILED DESCRIPTION OF VARIOUS EMBODIMENTS

According to an aspect there is provided an ambient commerce system. The ambient commerce system may include a sensor at an ambient commerce premises and a communication module. The ambient commerce system may include a processor coupled to the communication module and the sensor and a memory coupled to the processor. The memory may store processor-executable instructions which, when executed, cause the processor to: detect that an electronic device that has been previously configured to communicate with the ambient commerce system is at the ambient commerce premises, the electronic device associated with an entity; receive, from the electronic device, a wallet identifier, the wallet identifier uniquely identifying a particular wallet that is to be used to complete an ambient commerce transaction; identify, based on the sensor, one or more items that are to be associated with the ambient commerce transaction; and process the ambient commerce transaction for the identified one or more items using the particular wallet identified by the wallet identifier.

In some implementations, the instructions may further cause the processor to detect an indicator of a desire to complete the ambient commerce session, and wherein the ambient commerce transaction is processed in response to detecting the indicator of the desire to complete the ambient commerce session.

In some implementations, detecting an indicator of a desire to complete the ambient commerce session may include detecting the entity exiting a geofence defined for the ambient commerce premises.

In some implementations, the processor-executable instructions may further configure the processor to: receive, from the electronic device, an entity identifier, the entity identifier uniquely identifying the entity; and based on the entity identifier, obtain a profile for the entity. The profile may be used to process the ambient commerce transaction.

In some implementations, the profile may be used to perform authentication during the ambient commerce transaction.

In some implementations, the profile may include a voice print or facial profile which may be used to authenticate the entity.

In some implementations, the particular wallet is one of a plurality of wallets previously configured for use with the electronic device.

In some implementations, the wallet identifier may identity one of a plurality of wallets previously configured for use with the electronic device.

In some implementations, the wallet identifier may include a link to a computer system or module associated with the particular wallet.

In some implementations, the sensor may be a receptacle contents detector.

In another aspect, a computer-implemented method is described. The method includes: detecting that an electronic device that has been previously configured to communicate with the ambient commerce system is at the ambient commerce premises, the electronic device associated with an entity; receiving, from the electronic device, a wallet identifier, the wallet identifier uniquely identifying a particular wallet that is to be used to complete an ambient commerce transaction; identifying, based on the sensor, one or more items that are to be associated with the ambient commerce transaction; and processing the ambient commerce transaction for the identified one or more items using the particular wallet identified by the wallet identifier.

In some implementations, the method further includes detecting an indicator of a desire to complete the ambient commerce session. The ambient commerce transaction may be processed in response to detecting the indicator of the desire to complete the ambient commerce session.

In some implementations, detecting an indicator of a desire to complete the ambient commerce session includes detecting the entity exiting a geofence defined for the ambient commerce premises.

In some implementations, the method further includes: receiving, from the electronic device, an entity identifier, the entity identifier uniquely identifying the entity; and based on the entity identifier, obtaining a profile for the entity. The profile may be used to process the ambient commerce transaction.

In some implementations, the profile may be used to perform authentication during the ambient commerce transaction.

In some implementations, the profile may include a voice print or facial profile which is used to authenticate the entity.

In some implementations, the particular wallet may be one of a plurality of wallets previously configured for use with the electronic device.

In some implementations, the wallet identifier may identity one of a plurality of wallets previously configured for use with the electronic device.

In some implementations, the wallet identifier may include a link to a computer system or module associated with the particular wallet.

In some implementations, the sensor may be a receptacle contents detector.

In another aspect, there is provided a computer-readable storage medium. The computer-readable storage medium may be a non-transitory computer-readable storage medium. The computer-readable storage medium may have stored thereon instructions which, when executed, configure a processor and/or a computer system to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

Systems and methods for providing identity data to remote computer systems using a payment network are described below.

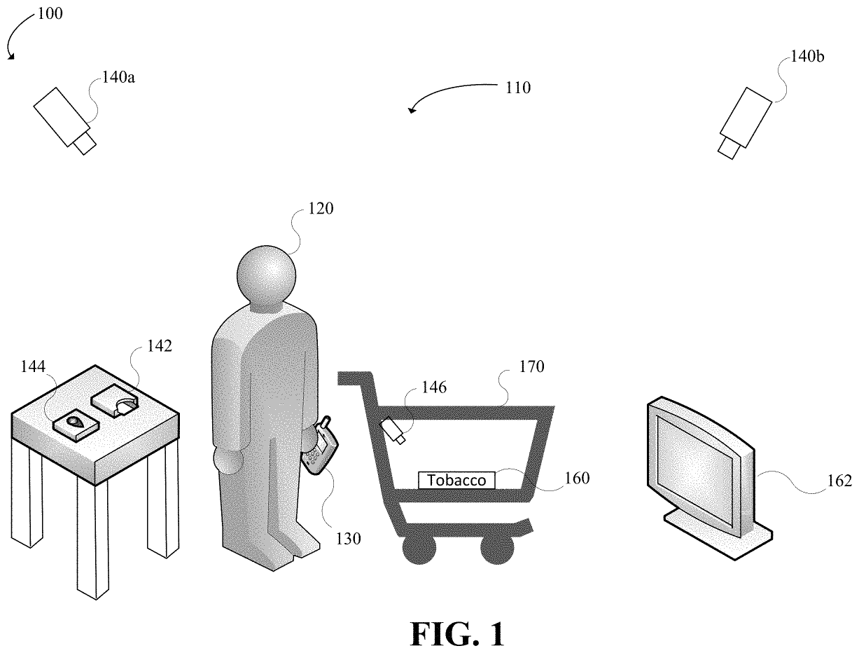

FIG. 1 is a plan view of an ambient commerce system 100 at an ambient commerce premises 110. The ambient commerce premises 110 may be a merchant location such as a store. The store may be a bricks-and-mortar establishment at which a customer may physically attend to shop. By way of example, the store may be or include any one or more of a grocery store, a department store, a clothing store, a thrift shop, a sporting goods store, a big box store, a pet store, a discount store, a warehouse store, a convenience store, or a store of another type.

The ambient commerce system 100 may be referred to as a cashier-less checkout system, an ambient checkout system, a sensor-based checkout system, a “just-walk-out” system or “grab and go” system. The ambient commerce system 100 includes one or more sensors which are used by the ambient commerce system to identify one or more items 160, 162 that are sold at the ambient commerce premises 110 and that are being purchased by an entity 120 such as a customer who is on site at the ambient commerce premises 110.

The items may be or include any products. By way of example, the items 160, 162 that are available for purchase via the ambient commerce system 100 may be or include groceries, electronic goods, sporting goods, accessories, clothing, or goods of another type.

The ambient commerce system 100 may include various sensors. One or more of the sensors may be on site at the ambient commerce premises 110. The sensors may generate respective sensor outputs which are used by the ambient commerce system 100 to facilitate ambient commerce. For example, the sensors may be or include one or more cameras 140a, 140b. The cameras may be located at various regions throughout the ambient commerce premises 110. In some implementations, the cameras 140a, 140b are part of a camera array or camera grid. The camera array or grid may provide complete or near complete coverage of all areas of the ambient commerce system 100 and the cameras may be configured to provide some overlap in camera coverage. In some implementations, each of the cameras may include multiple image sensors or the cameras may be configured in multiples such as pairs to enable the ambient commerce system 100 to determine and evaluate depth information as part of its analysis.

The sensors may include a receptacle contents detector 146. The receptacle contents detector 146 may be provided on or associated with a particular shopping receptacle 170. The particular shopping receptacle 170 is a container or other receptacle which may be used for holding or transporting goods while shopping. The particular shopping receptacle may, for example, be a shopping cart, shopping basket, shopping bag, or shopping bin.

The receptacle contents detectors 146 may be or include any one or more of: a camera, a barcode reader, a quick response (QR) code reader, a wireless tag reader such as a radio frequency identifier (RFID) reader or a sensor of another type.

In some implementations, one or more of the items that may be available for purchase may include a physical feature which facilitates identification of that item by one of the sensors. By way of example, the items may include a barcode which may be scanned by a barcode reader or camera, a QR code which may be scanned by a QR code reader or scanner, and/or a wireless tag such as an RFID tag.

The sensors included in the ambient commerce system 100 may include other types of sensors and readers including, for example, a biometric reader 144 and/or a token reader 142. The biometric reader 144 and/or the token reader 142 may be identity sensors. Identity sensors are sensors that are used to verify the identity of an entity 120. That is, identity sensors may be used to associate an entity 120 on the ambient commerce premises 110 with a profile or account.

The biometric reader 144 may be or include a fingerprint sensor, a facial recognition sensor, a retina scanner, or a sensor of another type. The token reader 142 may be a physical card reader such as a payment card reader including a credit card reader or debit card reader. In some implementations, the token reader 142 may be or include a near field communication (NFC) reader. The token reader 142 may be configured, in some implementations, to wirelessly read a token which may be stored on an electronic device 130 associated with an entity 120 or which may be stored on a physical card.

The sensors included in the ambient commerce system 100 may also include a microphone. The microphone may be used, for example, to verify the identity of an entity using a voiceprint. That is, the microphone may be used as an identity sensor.

The sensors included in the ambient commerce system 100 may be or include a gaze detection sensor. The gaze detection sensor may be or include one or more cameras. The gaze detection sensor may be an eye gaze detection sensor. The gaze detection sensor may be used to identify at item that the entity 120 is currently looking at. The gaze detection sensor may detect where the entity 120 is looking by identifying a portion of an ambient commerce premises 110 being looked at from an angular direction of a head and/or eyes. In some implementations, the gaze detection sensor may be configured to identify a gaze vector and an item may be identified if it is in a direction associated with the gaze vector.

The ambient commerce system 100 may be configured to detect the identity of an entity 120 and/or items 160, 162 that are being purchased using any one of a number of techniques. For example, in some implementations, identity may be detected using an identity sensor. For example, the biometric reader 144 and/or token reader 142 and/or one or more of the cameras 140a, 140b may be used to determine identity of an entity when the entity enters the ambient commerce premises 110. By way of example, in some implementations, upon entering the ambient commerce premises, the entity 120 may tap their electronic device at a token reader 142 which may then read a token from the electronic device which uniquely identifies the customer. In some implementations, multiple authentication techniques may be used to verify the identity of the customer. For example, the ambient commerce system may use two or more of: facial recognition; token acquisition and verification; retinal scanning; fingerprint scanning; and voiceprint scanning.

Further, in some implementations, identity of an entity 120 may be determined or verified using a shared secret such as a personal identification number (PIN) or secret code or phrase. The ambient commerce system 100 may include an input device for receiving input of the shared secret from an entity 120.

In some implementations, the ambient commerce system 100 may include or operate in cooperation with an electronic device 130 associated with an entity 120. The electronic device 130 may be a portable electronic device such as a smartphone, smartwatch or other wearable electronic device. The electronic device 130 may, in some implementations connect with the ambient commerce system 100 when it is within a geolocation or geofence associated with the ambient commerce system 100. For example, when the electronic device 130 is at the ambient commerce premises, it may connect with the ambient commerce system 100. Such communication may be performed via a long or short range communication protocol. In some implementations, the electronic device 130 may have an ambient commerce application stored thereon which is configured to enable the electronic device 130 to communicate with the ambient commerce system 100.

In at least some implementations, the electronic device 130 may be used to identity an entity 120. For example, the electronic device 130 may share its location (as determined from a location subsystem such as a GPS subsystem) with the ambient commerce system 100. The ambient commerce system 100 may determine that a particular entity 120 is on site at the ambient commerce premises when the location of that entity's electronic device is within a geofence defined for the ambient commerce premises. Additionally or alternatively, in some implementations the electronic device 130 may connect to the ambient commerce system 100 via a short range communication protocol such as NFC, Bluetooth™, WiFi, or a short range communication protocol of another type. In such implementations, the ambient commerce system may determine that a particular entity 120 is on site at the ambient commerce premises when the location of that entity's electronic device is in communication range of a short-range communication system associated with the ambient commerce premises.

In some implementations, the ambient commerce system 100 may use a biometric sensor associated with an entity's electronic device to further verify that a particular entity 120 is at the ambient commerce premises. For example, the ambient commerce system may, when the electronic device is determined to be on site, cause the electronic device to prompt the entity for input of a shared secret or a biometric such as a fingerprint. In this way, the ambient commerce system determines that the electronic device is on site and is being used by a particular entity 120. This may, for example, prevent a fraudster from circumventing the ambient commerce system by stealing another person's electronic device.

The electronic device 130 associated with an entity 120 may be used for other purposes instead of or in addition to identification and customer detection. For example, the electronic device 130 may include an output interface such as a display screen or speaker and the output interface may be used for outputting notifications generated by the ambient commerce system or by another system associated with the ambient commerce system.

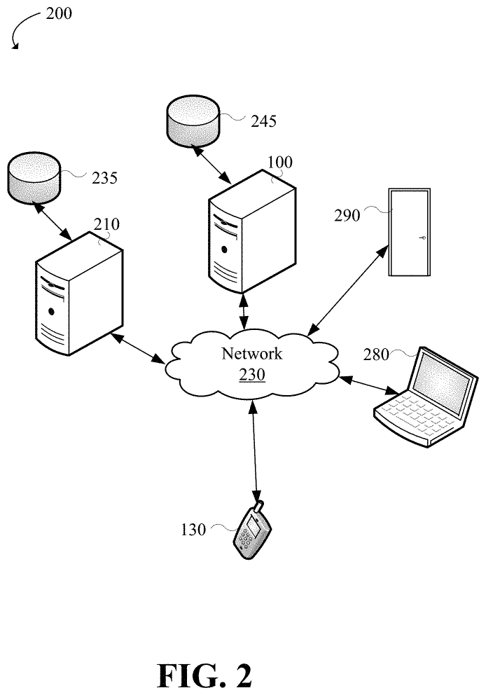

In at least some implementations, the electronic device 130 associated with the entity may be used to provide, to the ambient commerce system, a wallet identifier. The ambient wallet identifier may be used by the ambient commerce system to identify a wallet, such as a digital wallet, that is to be used to process an ambient commerce transaction. The wallet identifier may, in some instances, be or include a resource management server identifier. A resource management server may be a financial institution, for example, and the wallet identifier may identify which of a plurality of supported financial institutions is to be used for a particular entity for ambient commerce transactions with that entity. In some implementations, the resource management server identifier may identify a wallet server 210 (FIG. 2).

A wallet is a computer-based system and/or software provided on a computer-based system that may be used to effect a transfer of resources. The wallet may be also referred to as a digital wallet or an e-wallet. The wallet may be an electronic device, online service or software program. By way of example, the wallet may store payment information, such as a token, that may be used to process a transaction. The wallet may be or include an application that is stored on an electronic device 130 associated with an entity 120. By way of example, the application may be a mobile banking application or another application associated with a financial institution. In some implementations, the application may allow an entity to conduct electronic transactions with another party. In some implementations, the digital wallet may include or be an owned-resource wallet which uses owned resources, such as money that is deposited into a digital wallet, to effect a transfer. The owned-resource wallet may be a prefunded wallet. A prefunded wallet is a wallet in which resources are loaded onto the wallet before a transaction is processed. Examples of prefunded wallets may include a wallet provided by a financial institution, such as a bank, or wallets provided by third parties that operate, in whole or in part based on a pre-funding model; for example, Paypal™.

In some implementations, the digital wallet may be a borrowed-resource wallet which uses borrowed resources, or credit. By way of example, a borrowed resource wallet may be associated with a credit card.

The wallet is a computer-implemented wallet and it may be or include computer-executable instructions stored in memory of the electronic device 130 associated with the entity.

In some implementations, the electronic device 130 may store or be associated with a plurality of wallets. In some implementations, one or more of those wallets may be on-device wallets which are represent software or other computer data such as tokens stored in memory of the electronic device 130. In some implementations, one or more of those wallets may be cloud-based wallets which represent software or other computer data stored at a remote server, such as a remote wallet server. The remote wallet server may be accessed over a network, such as the Internet.

The electronic device 130 may also include other computer-executable instructions stored in memory of the electronic device 130 associated with the entity. For example, the electronic device may include an ambient commerce application which is configured to allow the electronic device to communicate with the ambient commerce system 100. As will be described in greater detail below, the ambient commerce application may enable the electronic device to communicate with the ambient commerce system to provide a wallet identifier to the ambient commerce system. Conveniently, this allows the ambient commerce system to use any wallet. That is, the ambient commerce system is not required to use a merchant-specific wallet; any wallet may be used.

FIG. 2 is a schematic operation diagram illustrating an operating environment of an example embodiment. FIG. 2 illustrates a system 200 which may be or include an ambient commerce system 100. The ambient commerce system 100 may be of the type described above with reference to FIG. 1, or a variation thereof. The ambient commerce system 100 may be or include a computer system. The computer system may be coupled with one or more sensors, as described with reference to FIG. 1 and may receive sensor output from such sensors.

The system 200 may also include an electronic device 130. The electronic device 130 may be as described above with reference to FIG. 1. For example, the electronic device 130 may be associated with an entity, such as a customer. The electronic device 130 may also be a computer system.

The electronic device 130 may be in communication with the ambient commerce system 100. Such communication may be via a direct connection or it may be an indirect connection. An indirect connection may be a connection that relies upon other intermediary computers or systems to relay messages. For example, as illustrated in FIG. 2, the ambient commerce system 100 and the electronic device 130 may be coupled to and communicate with one another via a network 230. The network 230 may be of various types. The network 230 may be a computer network. In some embodiments, the computer network may be an internetwork and may be formed of one or more interconnected computer networks. For example, the computer network may be or may include an Ethernet network, an asynchronous transfer mode (ATM) network, a wireless network, a telecommunications network or the like.

In some implementations, at least some communications between the electronic device 130 and the ambient commerce system 100 may occur over a direct connection. A direct connection may be a local communication method which may not require a network. For example, example direct connections include NFC, WiFi, and Bluetooth.

The ambient commerce system 100 may be or include a wallet server 210. The wallet server may provide a wallet or a digital wallet to entities. The wallet server 210 may track, manage, and maintain resources, adjudicate lending requests, lend resources and/or process transactions for a plurality of entities. For example, resources available for a plurality of entities may be specified in account data for such entities. The resources may, for example, include computing resources, such as memory or processor cycles. By way of further example, the resources may include stored value, such as fiat currency, which may be represented in one or more databases. For example, as shown in FIG. 2, the wallet server 210 may be coupled to a database 235, which may be provided in secure storage. The secure storage may be provided internally within the wallet server 210 or externally; the secure storage may, for example, be provided remotely from the wallet server 210. In some embodiments, the secure storage may include one or more data centers. The data centers may, for example, store data with bank-grade security.

The wallet server 210 may include a resource request processing engine (not shown in FIG. 1). A resource request processing engine may be implemented to automatically process resource transfer requests that are received at the wallet server. Specifically, the resource request processing engine may be configured to process requests to transfer resources that are associated with one or more resource accounts managed by the wallet server. The resource request processing engine may process resource transfer requests in accordance with defined handling actions. For example, the resource request processing engine may be configured to automatically process resource transfer requests without manual intervention by related entities for the resource transfer requests.

In some implementations, the wallet server 210 may be associated with a wallet application stored in memory of an electronic device 130 associated with an entity 120. By way of example, the wallet server 210 may provide back-end wallet functionality for a wallet stored on the electronic device 130.

The database 235 includes account data for a plurality of accounts associated with a plurality of entities. For example, the database 235 may include records for a plurality of accounts and at least some of the records may define a quantity of resources associated with an entity. For example, the entity that is associated with the electronic device 130 (which may also be referred to as a client device or customer device) may be associated with a resource account having one or more records in the database 235. The data records may reflect a quantity of stored resources that are associated with the entity. Such resources may include owned resources and, in at least some embodiments, borrowed resources (e.g., resources available on credit). The quantity of resources that are available to or associated with an entity may be reflected by a balance defined in an associated record such as, for example, a bank balance. In some implementations, a record for an account may be or include a resource parameter or enable the determination of a resource parameter. A resource parameter may, for example, indicate whether a particular entity associated with an account has access to a resource. In some implementations, the resource parameter may specify whether the particular entity associated with the account has access to a borrowed resource. In some implementations, the resource parameter may indicate a resource balance. The balance may be a balance associated with owned or borrowed resources.

The database 235 may also include identity verification data for entities having accounts in the database 235. The identity verification data may be or include a shared secret and/or biometric data such as a fingerprint, voiceprint and/or facial profile data. In at least some implementations, the wallet server 210 may share at least some of the identity verification data with the ambient commerce system 100 to assist with verifying identity of an entity at an ambient commerce premises 110. In other implementations, rather than share the identity verification data itself, the wallet server 210 may, instead, perform identity verification for the ambient commerce system and may confirm to the ambient commerce system the identity of an entity.

The database 235 may also include profiles for a plurality of entities. A profile may also be referred to as profile data and such data may be part of the account data, for example. A profile may be or include biographical data associated with an entity.

The wallet server 210 may, for example, be a financial institution system and the entity associated with an electronic device 130 may be a customer of a financial institution operating the financial institution system.

The wallet server 210 may be or include a computer system. The wallet server 210 may be in communication with the ambient commerce system 100. In the illustrated example, the wallet server 210 is in communication with the ambient commerce system 100 via the network 230.

As illustrated in FIG. 2, the ambient commerce system 100 may also include or be connected to a datastore 245 such as a database. The datastore 245 may be or include an inventory tracking data store. In some implementations, the datastore 245 may include product data for one or more items that are physically present in the ambient commerce premises 110. By way of example, the datastore 245 may include one or more parameters associated with items available at the ambient commerce premises 110. Such parameters may be referred to as item parameters. Example item parameters may be or include a value parameter and/or a class parameter. A value parameter may be an indicator of a cost or price of an item. Put differently, the value parameter for an item may represent an amount of resources required to transfer ownership of the item to an entity. The value parameter may, in some implementations, be expressed in units of currency, such as in dollars, Euros, Francs, etc.

The datastore 245 or another datastore may also include item identification data. The item identification data may be data that is used by the ambient commerce system to identify an item in the ambient commerce premises. By way of example, in a system that relies upon a code such as a barcode or QR code for identification of items, the item identification data may include a representation of the code for a particular item. By way of further example, in a system which relies upon packaging identification to identify items, the item identification data may include information about the packaging of an item. By way of further example, in a system that relies upon in-store placement information to identify items, the item identification data may include information defining a location within the ambient commerce premises at which a particular item is located. By way of example, the in-store placement information may specify an aisle number, region number, shelf number, etc. and such numbers (or other identifiers) may be known to the ambient commerce system so that the ambient commerce system is able to identify the particular items available at various regions of the ambient commerce premises.

By way of further example, in a system which relies upon a tag such as an RFID tag, the item identification data may specify a number or other identifier associated with the tag.

The ambient commerce system 100 may also include or be connected to an electronic device 280 associated with an in-store operator. The in-store operator may be an employee of a merchant operating the ambient commerce premises, for example. The electronic device 280 associated with the in-store operator may be of a type that is the same or similar to the electronic device 130 associated with the entity. By way of example, the electronic device 280 may be a laptop or desktop computer, a mobile computing device such as a smartphone, a smart watch or other wearable or an electronic device of another type. The electronic device 280 associated with the in-store operator may communicate with the ambient commerce system 100 by way of a network 230.

The ambient commerce system 100 may also include or be connected to an electrically controlled exit prevention device 290 such as an electrically controlled gate or door associated with an exit for the ambient commerce premises. The electrically controlled exit prevention device 290 may be controlled to prevent the entity from leaving the ambient commerce premises if the entity cannot be identified or if the system detects another error that would prevent successful processing of a payment. In some implementations, the electrically controlled exit prevention device 290 may be or include an electrically controlled lock. In some implementations, the electrically controlled exit prevention device 290 may be or include an automatic door which may be controlled to disable opening of the door to prevent exit by an entity.

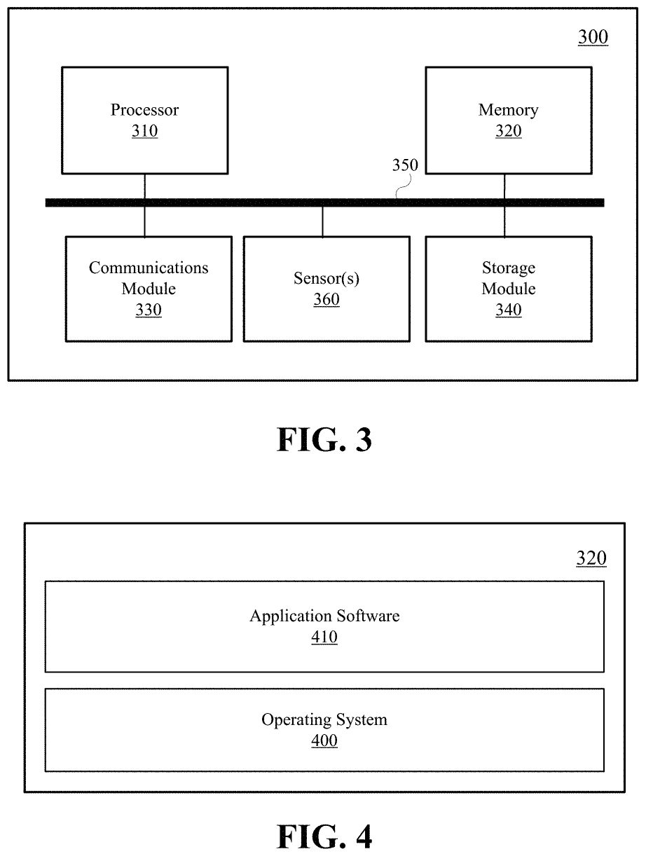

Referring now to FIG. 3, a high-level operation diagram of an example computer device 300 is shown. In some embodiments, the computer device 300 may be exemplary of one or more of the ambient commerce system 100, the electronic device 130, the electronic device 280 and/or the wallet server 210.

The example computer device 300 includes a variety of modules. The modules may be or include hardware. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application. The communications module may, in various implementations, be one or more of: a communications device, a communications interface, a communications chip, and/or a transceiver.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persistent storage other than the persisted storage (if any) accessible via the memory 320. In some embodiments, the storage module 340 may be used to store and retrieve data in a database. A database may be stored in persistent storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access remotely stored data using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

When the computer device 300 is exemplary of the ambient commerce system 100 or, in at least some implementations, the electronic device 130, the computer device may include one or more sensors 360. The one or more sensors 360 may be or include any one or more of the sensors described above with reference to FIG. 1.

When the computer device 300 is exemplary of the electronic device 130, the electronic device 130 may also include a location subsystem. The location subsystem may be coupled to the processor 310 to allow the processor to receive data defining a location of the electronic device 130. The location subsystem may be or include a geographic positioning system (GPS) and or a cellular triangulation system.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the ambient commerce system 100, the wallet server 210 and/or the electronic device 130.

While a single application 410 is illustrated in FIG. 4, in operation the memory 320 may include more than one application 410 and different applications 410 may perform different operations.

By way of example, in one implementation, the applications may include an ambient commerce application and one or more mobile wallet applications. These applications may be or include software modules. The mobile wallet application may also be referred to as a wallet. As noted above, the wallet may store or have access to stored payment information, such as a token, that may be used to process a transaction. The wallet may, in some implementations, interact with a wallet server 210 over a network 230. In one implementation, the mobile wallet application may be a banking application.

The ambient commerce application is configured to allow the electronic device to communicate with the ambient commerce system 100. As will be described in greater detail below, the ambient commerce application may enable the electronic device to communicate with the ambient commerce system to provide a wallet identifier to the ambient commerce system. The wallet identifier may identify one the wallets stored on the electronic device or a cloud-based wallet that is provided by a wallet server 210.

The wallet identifier may be stored in or otherwise associated with the ambient commerce system 100. The wallet identifier may be defined by a user of the ambient commerce application. For example, the ambient commerce application may include a user interface that includes a selectable option to define a wallet that is to be used when the ambient commerce application is engaged.

The wallet identifier may be a resource management server identifier or a financial institution identifier in some implementations.

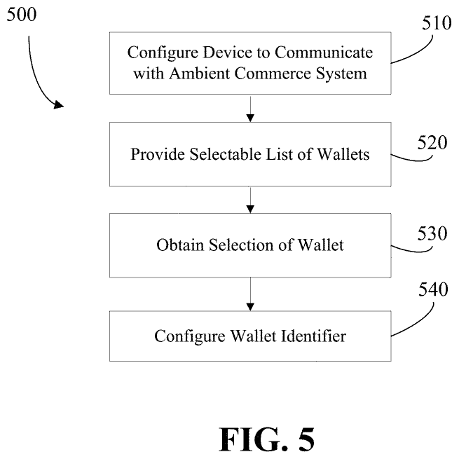

FIG. 5 is a flowchart showing operations performed by a system 200, such as the ambient commerce system 100 (FIGS. 1 and 2) and/or an electronic device 130 associated with an entity. The operations may be included in a method 500 which may be performed by the ambient commerce system 100 (FIGS. 1 and 2) and/or the electronic device 130 associated with the entity. For example, computer-executable instructions stored in memory of the ambient commerce system 100 (FIGS. 1 and 2) and/or the electronic device 130 associated with the entity may, when executed by one or more processors of the ambient commerce system 100 (FIGS. 1 and 2) and/or the electronic device 130 associated with the entity, configure the ambient commerce system 100 (FIGS. 1 and 2) and/or the electronic device 130 associated with the entity to perform the method 500 or a portion thereof. In some implementations, the method 500 may be performed by the electronic device 130 associated with the entity. In some implementations, while performing the method 500, the electronic device 130 may communicate with the ambient commerce system 100.

The operations of the method 500 may be performed to setup or configure a particular electronic device 130 associated with a particular entity to communicate with an ambient commerce system 100. The operations of the method 500 may be performed as part of an installation process of an ambient commerce application on the electronic device 130. For example, the method 500 may be performed immediately after or while the ambient commerce application is being installed on the electronic device 130.

In some implementations, the method 500 may not be performed at the time of installation of the ambient commerce application on the electronic device. Rather, the method 500 may be performed when the electronic device is detected to be on site at a particular ambient commerce premises for the first time. For example, the ambient commerce application may be supported at many different ambient commerce premises and, when the electronic device is determined to have entered a geofence associated with a new one of the supported ambient commerce premises, the method 500 or a portion thereof may be performed.

At an operation 510, the system performing the method 500, such as the electronic device 130 associated with the entity, may be configured to communicate with the ambient commerce system. In some implementations, at the operation 510, the electronic device may be configured to communicate with the ambient commerce system when the electronic device is at any supported ambient commerce premises. In other implementations, at the operation 510, the electronic device may be configured to communicate with the ambient commerce system or the portion of the ambient commerce system at a particular ambient commerce premises. For example, the electronic device may be configured to communicate with the ambient commerce system when the electronic device is at a particular store that is associated with the ambient commerce system but not at all stores associated with the ambient commerce system.

The configuration performed at the operation 510 may, in some implementations, configure the electronic device to communicate with the ambient commerce system using a short-range communication protocol such as Wi-Fi or Bluetooth. For example, each ambient commerce premises may have an associated short range communication system for the ambient commerce system that provides communication coverage over a coverage area that substantially overlaps the area of the ambient commerce premises. In some implementations, the operation 510 may including pairing the electronic device 130 with a short-range communication system included in the ambient commerce system 100 at the ambient commerce premises. For example, the pairing may be or include Bluetooth pairing.

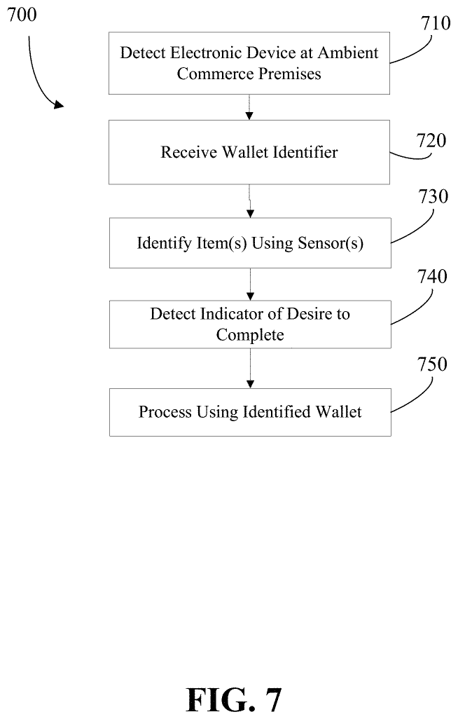

In some implementations, the configuration performed at the operation 510 may configure the electronic device to communicate with the ambient commerce system at numerous ambient commerce premises. In some instances, the configuration performed at the operation 510 may configure the electronic device to communicate with the ambient commerce system at all supported premises. For example, the electronic device may be configured to communicate with the ambient commerce system over a network 230 such as the Internet. In some such implementations, the configuration that is performed at the operation 510 may include configuring the electronic device to share a device location with the ambient commerce system 100. The device location may be a location determined by a location subsystem provided on the electronic device. The device location may be or include a GPS location or a cellular triangulation location. Configuring the electronic device to share its location may allow the ambient commerce system to determine when it is on site at an ambient commerce premises 110. For example, the location may allow the ambient commerce system to determine when the electronic device is within a geofence associated with a particular ambient commerce premises. In this way, when the electronic device is determined to be on site at a particular ambient commerce premises, an ambient commerce session may be initiated between the electronic device and the ambient commerce system, as will be described in greater detail below with reference to the method 700 of FIG. 7.

The method 500 may, at an operation 520, include providing a selectable list of wallets. The operation 520 may include, for example, identifying one or more wallets associated with the electronic device and/or the entity. The wallets may be identified by scanning memory of the electronic device 130. For example, the scanning may identify one or more mobile wallet applications stored on the electronic device. Such identification may be performed by comparing application identifiers for applications stored on the electronic device with identifiers from a list of supported wallets.

In some implementations, other techniques may be used to identify available wallets instead of or in addition to the scanning of memory. For example, one or more wallets may be identified through communications with one or more supported wallet servers 210. The communications may, for example, be performed using an application programming interface (API) associated with the wallet server(s) 210. By way of example, the ambient commerce system may poll one or more wallet servers 210 to determine whether an entity associated with an identifier, such as a particular email address or phone number, has an account with the wallet server 210.

Any wallets that are identified by scanning the memory of the electronic device or through communications with a wallet server 210 may be included in the selectable list of wallets that is provided at the operation 520.

Other techniques may be used to identify wallets that are that are to be included in a selectable list. For example, the wallets may be identified based on a geographic location associated with an entity or electronic device. For example, certain wallets may only be supported in certain regions and, based on a location of an entity or the electronic device, supported wallets may be identified and included in the selectable list.

In some implementations, one or more default wallets may be included in the selectable list. Such wallets may be included even if there is no indication available that suggests that the entity or electronic device uses such wallets.

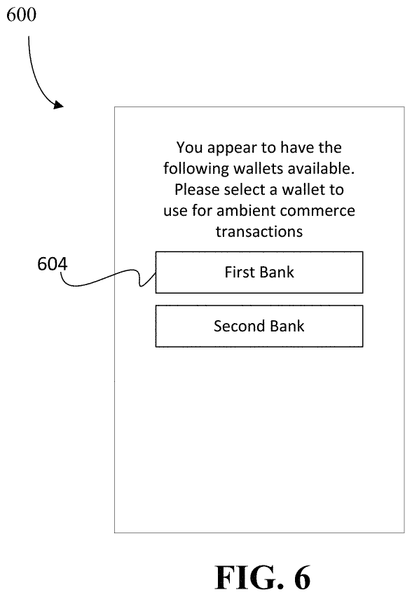

Referring now to FIG. 6, an example interface 600 is illustrated. The interface 600 may be displayed on the electronic device 130. The interface 600 may be displayed on a display of the electronic device 130. For example, an ambient commerce application may display the interface 600. The interface 600 may be displayed while operation 520 of the method 500 is performed.

The interface includes one or more selectable options 604 for defining a wallet that is to be used for ambient commerce transactions. In the illustrated example, the selectable options 604 include a selectable listing of wallets. One or more of the wallets may be wallets that are identified as being installed or configured on the electronic device. One or more of the wallets may be wallets that are identified, by a wallet server 210, as being associated with a particular entity. One or more of the wallets may be wallets that are identified as being available in a geographic region associated with the electronic device and/or the entity. One or more of the wallets may be default wallets that are available even when there is no indication suggesting that the entity or electronic device uses such a wallet.

The selectable options 604 may be ordered based on a determined likelihood of a particular wallet being selected. For example, wallets that are determined to be found in memory of the electronic device may be listed in a preferential location in the list (e.g., higher in the list) than wallets for which there is no indication available that suggests that the entity or electronic device uses such wallets. In some implementations, the ordering may be based on crowd-sourced preferences. That is, preferences may be determined based on which wallets are configured for other entities that have previously configured wallets in the ambient commerce system. Such preferences may be geographic-based. For example, the ambient commerce system and/or ambient commerce application may identify wallet preferences for other users in a geographic region in which the electronic device and/or entity is located. The preference may influence the display order of the wallets.

Referring again to FIG. 5, at an operation 530, the electronic device and/or the wallet server 210 may receive a selection of a wallet. The selection may be received when one or more of the selectable options 604 are selected.

Then, at an operation 540, the electronic device and/or the ambient commerce system 100 may configure a wallet identifier that is to be used for that electronic device. The wallet identifier is an identifier that is associated with the selected wallet. An appropriate wallet identifier may, for example, be retrieved from memory based on the selection. In some implementations, the wallet identifier may be or include a unique identifier of a wallet. In some implementations, the wallet identifier may include or be associated with a link to a computer system or module (such as an application on the electronic device) associated with the wallet.

While not illustrated in FIG. 5, during the method 500, electronic device may also cooperate with the ambient commerce system 100 to assign the entity an entity identifier. The entity identifier is an identifier that uniquely identifies the entity to the ambient commerce system 100. The entity identifier may be or include a unique number. In some implementations, the entity identifier may be or include a unique alias, such as an email address or telephone number associated with the entity. The entity identifier may be assigned in a variety of manners. By way of example, the entity identifier may be assigned based on input received from at the electronic device. For example, the electronic device may prompt for input of an alias and the entity identifier may then be assigned based on this alias. By way of example, in one implementation, the entity identifier may be the alias itself. In another implementation, the entity identifier may be deterministically determined from the alias. For example, the entity identifier may be determined by applying a hash to the alias. In yet another example, an entity identifier may be assigned based on a last-assigned entity identifier. For example, entity identifiers may be assigned sequentially.

In some implementations, the entity identifier may be stored on both the electronic device 130 associated with the entity and on another system, such as the ambient commerce system 100. The ambient commerce system may also store or have access to a profile for the entity and may associate the profile with the entity identifier so that the profile may be retrieved based on the entity identifier. The entity identifier and/or the profile may be stored in a datastore 245 associated with the ambient commerce system 100.

The profile may include authentication data, which may also be referred to as identity verification data. The identity verification data may, in some implementations, be configured during operation of the method 500 or thereafter. The identity verification data may be defined based on data received from the electronic device 130 associated with the entity.

The identity verification data may be or include a shared secret and/or biometric data such as a fingerprint, voiceprint and/or facial profile data.

Referring now to FIG. 7, a further method 700 will now be described. The method 700 of FIG. 7 may be performed after the method 500 of FIG. 5 has been performed to complete setup so that an electronic device 130 is able to communicate with an ambient commerce system 100 when the electronic device 130 is on site at an ambient commerce premises associated with the ambient commerce system.

FIG. 7 is a flowchart showing operations performed by a system 200, such as the ambient commerce system 100. The operations may be included in a method 700 which may be performed by the ambient commerce system 100 (FIGS. 1 and 2). For example, computer-executable instructions stored in memory of the ambient commerce system 100 (FIGS. 1 and 2) may, when executed by one or more processors of the ambient commerce system 100 (FIGS. 1 and 2), configure the ambient commerce system 100 (FIGS. 1 and 2) to perform the method 700 or a portion thereof. The method 700 may be performed in cooperation with the electronic device 130 associated with the entity. In some implementations, while performing the method 700, the electronic device 130 may communicate with the ambient commerce system 100.

The method includes, at operation 710, detecting that an electronic device 130 that has been previously configured to communicate with the ambient commerce system 100 is at an ambient commerce premises associated with the ambient commerce system 100.

The electronic device 130 detected at the operation 710 may be an electronic device associated with an entity. More specifically, the electronic device may be associated with an entity that has previously been registered with the ambient commerce system 100 using techniques such as those described above with reference to FIG. 5.

The detection of the electronic device may be performed in any one of a number of ways. In one example, the electronic device 130 may be detected when it is within a communication range of a short range communication subsystem associated with the ambient commerce system. When the electronic device 130 is within this range, it may connect to the ambient commerce system via the short range communication subsystem and, when the ambient commerce system detects such a connection, it may determine that the electronic device is at the ambient commerce premises associated with the ambient commerce system 100.

In another example, it may be that the detection is performed based on a location determined by a location subsystem of the electronic device 130. For example, the electronic device 130 may be configured to share a device location with the ambient commerce system 100. The location may be a GPS location or a cellular triangulation location, for example. Based on the device location, the ambient commerce system may determine whether the electronic device is within a geofence associated with the ambient commerce premises. If the electronic device 130 is determined to be within the geofence, then it may be determined to have been detected within the ambient commerce premises 110.

In another example, it may be that the detection is performed when the entity taps the electronic device at a token reader 142 or when the entity brings the electronic device near the token reader 142. For example, an entity may be required to tap their electronic device upon entry to the ambient commerce premises and, when the entity taps the electronic device, the ambient commerce system may determine that the electronic device is on site at the ambient commerce premises.

Accordingly, the ambient commerce system 100 may, at the operation 710, determine that the electronic device is at the ambient commerce premises. Additionally or alternatively, in some implementations, the electronic device 130 may, at the operation 710, determine that it is at the ambient commerce premises. The electronic device 130 may perform such a determination in a similar manner as that which may be used by the ambient commerce system 100 to determine that the electronic device is on site at the ambient commerce premises. For example, it may be that the electronic device 130 determines that it is at the ambient commerce premises when it is within communication range of the ambient commerce premises or when its location is a location that is within a geofence defined for the ambient commerce premises.

When the electronic device 130 is detected at the ambient commerce system, it may transmit, to the ambient commerce system 100, a wallet identifier. The wallet identifier may be received at the ambient commerce system 100 at an operation 720. The wallet identifier uniquely identifiers a particular wallet that is to be used to complete an ambient commerce transaction. The wallet identifier may be the wallet identifier that was configured at the operation 540 of the method 500 of FIG. 5.

The wallet identifier may, in some implementations, be received at the ambient commerce system 100 when the electronic device 130 is tapped at a short-range communication subsystem such as a token reader 142. As noted in the discussion of the operation 710, it may be that an entity is required to tap the electronic device at the token reader 142 upon entry into the ambient commerce premises and the tapping may cause the wallet identifier to be transmitted to the ambient commerce system. A tap, as used herein, is intended to include any action that allows for communication over a very short range communication medium, such as NFC. Tapping need not require physical contact of items being tapped in all implementations.

The wallet identifier may identify a particular wallet. That is, the wallet identifier may identify a specific wallet. In some instances, the electronic device may have been previously configured for use with a plurality of wallets. For example, the electronic device may have a number of different mobile wallet applications, each representing a separate wallet, that are stored in memory of the electronic device and the wallet identifier may indicate a specific one of the installed wallets. Accordingly, the particular wallet that is identified by the wallet identifier may be one of a plurality of wallets previously configured for use with the electronic device.

As noted in the discussion of FIG. 5, the wallet identifier may include a link to a computer system or module associated with the particular wallet. By way of example, the link may be or include an executable file associated with a mobile wallet application on the electronic device. In some implementations, the link may be a link to a wallet server 210. The link may, for example, be or include an address of the wallet server 210.

Next, at an operation 730, the ambient commerce system 100 may identify, based on one or more sensors at the ambient commerce premises, one or more items that are to be associated with an ambient commerce transaction. The sensor may be a sensor of the type described above. For example, the sensor may be or include one or more of a receptable contents detector 146 or a camera 140a, 140b. In some implementations, the identification may include scanning a code, such as a barcode or QR code, on the item. In some implementations, other computer vision-based techniques may be used to identify the item(s). For example, product identification may be performed using cameras 140a, 140b.

The identification at the operation 730 may be performed using item identification data that may be stored in the datastore 245. The item identification data may be data that is used by the ambient commerce system to identify an item in the ambient commerce premises. By way of example, in a system that relies upon a code such as a barcode or QR code for identification of items, the item identification data may include a representation of the code for a particular item. By way of further example, in a system which relies upon packaging identification, the item identification data may include information about the packaging of an item. By way of further example, in a system that relies upon in-store placement information to identify items, the item identification data may include information defining a location within the ambient commerce premises at which a particular item is located. By way of example, the in-store placement information may specify an aisle number, region number, shelf number, etc. and such numbers (or other identifiers) may be known to the ambient commerce system so that the ambient commerce system is able to identify the particular items available at various regions of the ambient commerce premises.

The item(s) that are identified at the operation 730 are items that the entity has indicated an interest in purchasing. The items may be items that have been added to a shopping receptable associated with an entity. In some implementations, the ambient commerce system creates, in memory, a virtual shopping card based on items that are detected to be in a physical shopping receptacle. The detection of items may be performed using sensor outputs.

In some implementations, the ambient commerce system may, at an operation 740, detect an indicator of a desire to complete the ambient commerce session. Put differently, the ambient commerce system may detect an indicator of readiness to complete an ambient commerce transaction. The ambient commerce system may detect the indicator of a desire to complete the ambient commerce session based on a sensor output of one or more of the sensors at the ambient commerce system. For example, the ambient commerce system may detect the indicator of a desire to complete the ambient commerce session when it detects, based on a sensor output, that the entity has left or is attempting to leave the ambient commerce premises. This may be detected in a variety of ways. For example, in some implementations, detecting an indicator of a desire to complete the ambient commerce session may include detecting the entity exiting a geofence defined for the ambient commerce premises. In some implementations, a location provided by the electronic device 130 associated with the entity may be used to determine that the entity has exited the geofence defined for the ambient commerce premises.

In some implementations, the ambient commerce system 100 may, in some implementations, determine that the entity has left or attempted to leave the ambient commerce premises based on the output of a camera 140a, 140b. For example, based on the output of one or more of the cameras, it may be determined that the entity has travelled through an exit of the ambient commerce premises. In other implementations, the ambient commerce system 100 may determine that the entity has left or attempted to leave when the electronic device 130 associated with that entity is no longer in communication range of a short-range communication system associated with the ambient commerce premises.

At an operation 750, the ambient commerce system may process the ambient commerce transaction for the identified one or more items using the particular wallet identified by the wallet identifier. In at least some implementations, the ambient commerce transaction may be processed in response to detecting the indicator of the desire to complete the ambient commerce session at the operation 730.

In at least some implementations, the ambient commerce transaction may be processed using the particular wallet identified by the wallet identifier by causing the electronic device to activate the particular wallet on the electronic device. In some instances, the ambient commerce transaction may be processed by sending a message to the wallet server 210 to process the transaction. For example, the ambient commerce transaction may be processed by sending an electronic signal to the wallet server 210. The electronic signal may include entity identifying information which uniquely identifies the entity at the wallet server 210 as being associated with a particular account. The entity identifying information may be, for example, an alias associated with the entity such as an email address or telephone number.

The ambient commerce transaction may be processed by initiating a transfer, using the particular wallet, of an amount of resources that is determined, by the ambient commerce system, based on the value of the identified items. The value of the identified items may be determined from value parameters for each of the identified items. The value parameters may be retrieved from the datastore 245.

Conveniently, in this way, an ambient commerce transaction may be performed with an entity's preferred wallet rather than requiring that entity to use a single merchant-specific wallet in order to engage in ambient commerce.

If the ambient commerce transaction at operation 750 is determined, by the ambient commerce system 100 to have failed, then the ambient commerce system may perform an operation to prevent the entity from exiting the ambient commerce premises 110. For example, an electrically controlled exit prevention device 290 may be activated to prevent the entity from exiting the ambient commerce premises. Example failures may occur when the particular wallet rejects the transaction, where there is an error in the wallet identifier, where there is a communication error, etc.

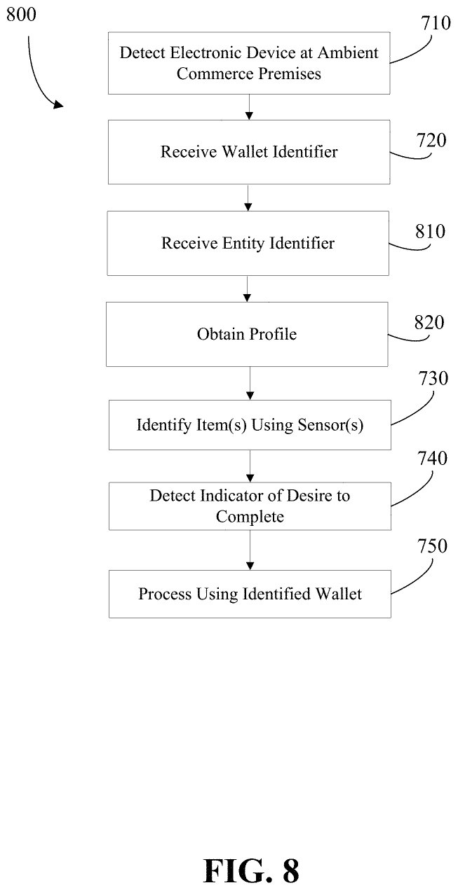

Referring now to FIG. 8, a further method 800 will now be described. The method 800 of FIG. 8 may be performed after the method 500 of FIG. 5 has been performed to complete setup so that an electronic device 130 is able to communicate with an ambient commerce system 100 when the electronic device 130 is on site at an ambient commerce premises associated with the ambient commerce system.

FIG. 8 is a flowchart showing operations performed by a system 200, such as the ambient commerce system 100. The operations may be included in a method 800 which may be performed by the ambient commerce system 100 (FIGS. 1 and 2). For example, computer-executable instructions stored in memory of the ambient commerce system 100 (FIGS. 1 and 2) may, when executed by one or more processors of the ambient commerce system 100 (FIGS. 1 and 2), configure the ambient commerce system 100 (FIGS. 1 and 2) to perform the method 800 or a portion thereof. The method 800 may be performed in cooperation with the electronic device 130 associated with the entity. In some implementations, while performing the method 800, the electronic device 130 may communicate with the ambient commerce system 100.

The method 800 of FIG. 8 includes a number of operations in common with the method 700 of FIG. 7 and the description of such operations will not be repeated for the sake of brevity. For example, the method 800 includes may include one or more of the operations 710, 720, 730, 740, 750 discussed above with reference to FIG. 7.

The method 800 of FIG. 8 also includes an operation 810 in which the ambient commerce system receives an entity identifier. The entity identifier may be received together with the wallet identifier. For example, these identifiers may be part of a common message or signal such that the operations 720 and 810 may be performed together.

The entity identifier is received from the electronic device 130. The entity identifier may uniquely identify the entity. For example, the entity identifier may be an identifier that uniquely identifies the entity to the ambient commerce system 100. The entity identifier may be or include a unique number. In some implementations, the entity identifier may be or include a unique alias, such as an email address or telephone number associated with the entity. The entity identifier may be assigned in a variety of manners. By way of example, the entity identifier may be assigned based on input received from at the electronic device. For example, the electronic device may prompt for input of an alias and the entity identifier may then be assigned based on this alias. By way of example, in one implementation, the entity identifier may be the alias itself. In another implementation, the entity identifier may be deterministically determined from the alias. For example, the entity identifier may be determined by applying a hash to the alias. In yet another example, an entity identifier may be assigned based on a last-assigned entity identifier. For example, entity identifiers may be assigned sequentially.

The entity identifier may have been configured during the method 500 of FIG. 5.

Next, at an operation 820, the ambient commerce system may obtain a profile for the entity. The profile may be obtained based on the entity identifier. The profile may be obtained from memory associated with the ambient commerce system. The profile may include data that may be used to authenticate the entity. That is, the profile may include identity verification data that may be used to verify the identity of the entity. The profile may, for example, include a representation of a voiceprint, fingerprint or face, or it may include a stored shared secret that is known to the entity 120 and that may be used to identify the entity.

The profile may be obtained from a datastore 245 associated with the ambient commerce system 100 or it may be obtained from a database 235 associated with the wallet server 210. In some implementations, the profile for the entity is obtained from a financial institution system associated with the entity. For example, the profile, or a portion thereof, may be obtained from a wallet server 210 that is associated with the entity. Since the entity has provided a wallet identifier to the ambient commerce system, the ambient commerce system may use the identifier to identify an appropriate wallet server 210 from which the profile for the entity may be obtained.

The profile for the entity may be obtained based on the entity identifier. For example, the entity identifier may be used to identify the appropriate profile to be used.

The profile may be used at the operation 750 when the ambient commerce transaction is processed. That is, the profile that is obtained at the operation 820 may be used at the operation 750 to process the ambient commerce transaction. For example, the profile may be used to perform authentication during the ambient commerce transaction. That authentication may be performed to confirm that the entity is the operator of the electronic device. For example, the profile may include a voice print, facial profile or shared secret which may be used to verify an identity of the entity. By way of example, the entity may be prompted to speak a phrase into a microphone to allow a voice print associated with the entity to be verified. In other implementations, the entity may be prompted to input a shared secret using an input device associated with the electronic device. In other implementations, the cameras 140a, 140b may obtain images of the entity and such images may be used to verify identity using a facial profile for the entity.

Variations of the methods and systems described herein are contemplated. For example, in one possible variation, the wallet server 210 may take a more active role in authentication of an entity. For example, the ambient commerce system 100 may send data such as image or audio data to the wallet server 210 and the wallet server may use such data to authenticate an entity before performing an ambient commerce transaction. The image data may be data from one or more of the cameras 140a, 140b at the ambient commerce premises. The audio data may be data from one or more microphones at the ambient commerce premises. The wallet server may receive such data and perform authentication based on such data. For example, the wallet server may perform facial recognition on the image data using a facial profile stored for the entity or it may perform voice recognition on the audio data using a voiceprint stored for the entity. Conveniently, this variation allows the wallet server 210 to maintain the secrecy of profiles for entities that use the wallet server 210.

Any examples involving a general purpose computer, aspects of this application transform the general-purpose computer into a special-purpose computing device when configured to execute the instructions described herein.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. An ambient commerce system comprising:
a sensor at an ambient commerce premises;
a communication module;
a processor coupled to the communication module and the sensor; and
a memory coupled to the processor, the memory storing processor-executable instructions which, when executed, cause the processor to:
detect that an electronic device that has been previously configured to communicate with the ambient commerce system is at the ambient commerce premises, the electronic device associated with an entity;
receive, from the electronic device, a wallet identifier, the wallet identifier uniquely identifying a particular wallet that is to be used to complete an ambient commerce transaction;
identify, based on the sensor, one or more items that are to be associated with the ambient commerce transaction; and
process the ambient commerce transaction for the identified one or more items using the particular wallet identified by the wallet identifier.

2. The ambient commerce system of claim 1, wherein the instructions further cause the processor to:
detect an indicator of a desire to complete an ambient commerce session, and wherein the ambient commerce transaction is processed in response to detecting the indicator of the desire to complete the ambient commerce session.

3. The ambient commerce system of claim 2, wherein detecting an indicator of a desire to complete the ambient commerce session includes detecting the entity exiting a geofence defined for the ambient commerce premises.

4. The ambient commerce system of claim 1, wherein the processor-executable instructions further configure the processor to:
receive, from the electronic device, an entity identifier, the entity identifier uniquely identifying the entity; and
based on the entity identifier, obtain a profile for the entity,
wherein the profile is used to process the ambient commerce transaction.

5. The ambient commerce system of claim 4, wherein the profile is used to perform authentication during the ambient commerce transaction.

6. The ambient commerce system of claim 4, wherein the profile includes a voice print or facial profile which is used to authenticate the entity.

7. The ambient commerce system of claim 1, wherein the particular wallet is one of a plurality of wallets previously configured for use with the electronic device.

8. The ambient commerce system of claim 1, wherein the wallet identifier identifies one of a plurality of wallets previously configured for use with the electronic device.

9. The ambient commerce system of claim 1, wherein the wallet identifier includes a link to a computer system or module associated with the particular wallet.

10. The ambient commerce system of claim 1, wherein the sensor is a receptacle contents detector.

11. A computer-implemented method comprising:
detecting that an electronic device that has been previously configured to communicate with an ambient commerce system is at an ambient commerce premises, the electronic device associated with an entity;
receiving, from the electronic device, a wallet identifier, the wallet identifier uniquely identifying a particular wallet that is to be used to complete an ambient commerce transaction;
identifying, based on a sensor, one or more items that are to be associated with the ambient commerce transaction; and
processing the ambient commerce transaction for the identified one or more items using the particular wallet identified by the wallet identifier.

12. The method of claim 11, further comprising:
detecting an indicator of a desire to complete an ambient commerce session, and wherein the ambient commerce transaction is processed in response to detecting the indicator of the desire to complete the ambient commerce session.

13. The method of claim 12, wherein detecting an indicator of a desire to complete the ambient commerce session includes detecting the entity exiting a geofence defined for the ambient commerce premises.

14. The method of claim 11, further comprising:
receiving, from the electronic device, an entity identifier, the entity identifier uniquely identifying the entity; and
based on the entity identifier, obtaining a profile for the entity,
wherein the profile is used to process the ambient commerce transaction.

15. The method of claim 14, wherein the profile is used to perform authentication during the ambient commerce transaction.

16. The method of claim 14, wherein the profile includes a voice print or facial profile which is used to authenticate the entity.

17. The method of claim 14, wherein the particular wallet is one of a plurality of wallets previously configured for use with the electronic device.

18. The method of claim 14, wherein the wallet identifier identifies one of a plurality of wallets previously configured for use with the electronic device.

19. The method of claim 14, wherein the wallet identifier includes a link to a computer system or module associated with the particular wallet.

20. The method of claim 14, wherein the sensor is a receptacle contents detector.
